(19) United States
(12) Patent Application Publication
(10) Pub. No.: US 2005/0233186 A1
(43) Pub. Date: Oct. 20, 2005

(54) Liquid-fuel fuel cell, operation monitoring method for monitoring operation thereof, and operation monitoring device

(76) Inventors: Okuyama Ryoichi, Osaka (JP); Takatomo Takemitsu, Osaka (JP); Eiichi Nomura, Shiga (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 10/518,228

(22) PCT Filed: Jun. 16, 2003
(86) PCT No.: PCT/JP03/07622

§ 371 Date: Dec. 16, 2004

(30) Foreign Application Priority Data
Jun. 17, 2002 (JP) 2002-176303
Jun. 28, 2002 (JP) 2002-189362

(51) Int. Cl. H01M 8/04; H01M 8/10; H01M 8/24

(52) U.S. Cl. 429/13; 429/23; 429/30; 429/32

(57) ABSTRACT

A liquid-fuel feed fuel cell disclosed with a unit cell that has a structure in which a negative electrode and a positive electrode are opposed with a polymer electrolyte having a proton conductivity interposed between them. A liquid fuel is supplied to the negative electrode and air is supplied to the positive electrode. The liquid-fuel feed fuel cell has a cell stack where unit cells are stacked. Additionally, an operation monitoring method for monitoring the operation and an operation monitoring device are disclosed. To prevent degradation, the liquid-fuel feed fuel cell has at least one of the following functions: increasing the supply of air or liquid fuel, issuing an alarm, decreasing the output current, and stopping the operation of the fuel cell when it is detected that the potential between the negative and positive electrodes monitored for at least one cell is below a predetermined negative potential.

### FIELD OF THE INVENTION

The present invention relates to liquid-fuel feed fuel cell and its system, operation monitoring method of fuel cell, and operation monitoring device.

### BACKGROUND OF THE INVENTION

Much attention has been given to fuel cells using liquid fuel, such as direct methanol type fuel cells. In a liquid-fuel feed fuel cell, an anode (fuel electrode) and a cathode (air electrode) are jointed onto both faces of a polymer electrolyte having proton conductivity. This assembly is provided between separators made of graphite plate, etc. for supplying a liquid fuel to the anode and an oxidant gas to the cathode, respectively to make a unit cell. A plurality of the unit cells is stacked to make a cell stack. The anode is produced by coating a porous carbon paper with carbon powder supporting platinum(Pt)-ruthenium(Ru) catalyst therein. The cathode is produced by coating a similar carbon paper with carbon powder supporting Pt catalyst therein. As for liquid fuels, methanol aqueous solution as well as isopropanol aqueous solution, dimethylether-water system, etc. are used. Methanol aqueous solution has a concentration of, for example, around 3 wt %.

The present inventors found phenomena that when the output current was excessive or when the supply of air or the supply of a liquid fuel was deficient, the exhausted fuel on the anode side blackened and the cell characteristics deteriorated irreversibly. Such phenomena did not occur in fuel cells using similar electrodes and a similar polymer electrolyte when hydrogen was used as fuel. They occurred only when a liquid fuel was used. Next, the exhausted fuel on the anode side was analyzed. As a result, ruthenium was detected. It is considered that ruthenium was eluted into the fuel from the Pt—Ru catalyst of the anode.

The present inventors estimated the elution mechanism of ruthenium as follows. When the supply of a fuel or the supply of an oxidant is deficient or when an excessive output current is taken out, the electric potential between the cathode and the anode might be reversed. For example, when unit cells are series-connected together, the reversal of the electric potential tends to occur in a unit cell under an adverse condition because a large output current flows in other unit cells that are series-connected. In liquid-fuel feed fuel cells, there exists in a fuel, for example, a small amount of formic acid resulting from oxidation of methanol and/or dimethyl ether or a small amount of isopropionic acid resulting from oxidation of propanol, thus the exhausted fuel can be regarded as a liquid electrolyte of weak acidity. When the electric potential of the cathode in relation to the anode is reversed in the liquid electrolyte to drop to, for example, −600 mV or under, ruthenium of the anode will elute. Naturally, this phenomenon is irreversible. Moreover, as the output voltage of a unit cell is about several hundred millivolts and these unit cells are supposed to be used as a cell stack wherein cells are series-connected together, potential reversal tends to occur in a cell that is under the worst conditions. In this specification, reversal of the electric potential of the cathode and that of the anode is defined as potential reversal, and when potential reversal becomes excessive, ruthenium will elute from the anode. As the cathode normally contains no ruthenium, there will be no elution of ruthenium from the cathode.

### SUMMARY OF THE INVENTION

An object of the present invention is to prevent degradation of liquid-fuel feed fuel cell due to potential reversal.

The liquid-fuel feed fuel cell according to the present invention is characterized in that said unit cell or at least one unit cell in said cell stack is provided with a potential monitor for monitoring the electric potential between the anode and the cathode thereof, and said potential monitor has function of executing at least one of increasing the supply of liquid fuel or the supply of oxidant gas, giving an alarm, reducing the output current of the cell and suspending the operation of the cell. In this specification, the electric potential between the anode and the cathode is defined to be positive when the electric potential of the cathode is higher than that of the anode.

With this arrangement, potential reversal of the fuel cell can be detected, and elution of ruthenium in the anode can be prevented. The electric potential for detecting potential reversal is, for example, in a range of from +200 to −500 mV per cell, preferably, in a range of from 0 to −500 mV, and more preferably, in a range of from −200 to −500 mV. To monitor the electric potential of a cell group wherein a plurality of cells are series-connected together, it is so arranged that potential reversal can be detected when any one of the cells reaches the above-mentioned detection potential and other cells maintain normal electric potentials.

The liquid-fuel feed fuel cell system according to the present invention is characterized in that said liquid-fuel feed fuel-cell system is provided with at least two cell stacks wherein a plurality of the unit fuel cells are series-connected together, said cell stacks each having a plurality of cell groups each consisting of at least one unit cell, and corresponding cell groups of the respective cell stacks being parallel-connected together. With this arrangement, potential reversal occurring in a cell under worse conditions can be prevented by another unit cell being parallel-connected thereto. Preferably, the electric potential between the anode and the cathode of at least one unit cell constituting a cell group or a cell group is monitored by a potential monitor.

The operation monitoring method of the liquid-fuel feed fuel cell according to the present invention is characterized in that the electric potential between the anode and the cathode of a unit cell or at least a unit cell of said cell stack is monitored, and when said electric potential is detected to be at a predetermined negative electric potential or under, at least one of increasing the supply of liquid fuel or the supply of oxidant gas, giving an alarm, reducing the output current of the cell and suspending the operation of the cell will be made. Preferably, at least two sets of said cell stacks are provided, said cell stacks each having a plurality of cell groups each comprising at least one unit cell, and corresponding cell groups of said cell stacks being parallel-connected together.

The operation monitoring device of the liquid-fuel feed fuel cell according to the present invention is characterized in that said operation monitoring device is provided with a potential monitor that monitors the electric potential between the anode and the cathode of a unit cell or at least one unit cell of said cell stacks and a controller that will execute at least one of increasing the supply of liquid fuel or the supply of oxidant gas, giving an alarm, reducing the output current of the cell and suspending the operation of the cell when said electric potential is detected to be at a predetermined negative electric potential or under by the potential monitor. Preferably, at least two sets of said cell stacks are provided, said cell stacks each having a plurality of cell groups comprising at least one unit cell and the corresponding cell groups of said cell stacks being parallel-connected together.

### BRIEF DESCRIPTION OF THE DRAWINGS

FIG. 1 illustrates how cell characteristics are changed after a reverse voltage of −400 mV is applied to a unit cell and after a reverse voltage of −600 mV is applied to an identical unit cell, in terms of the relationship between output current and output voltage.

FIG. 2 illustrates the structure of the direct methanol fuel cell of an embodiment of the present invention.

FIG. 3 illustrates the operation monitoring method of the direct methanol fuel cell of the embodiment.

FIG. 4 illustrates the operation monitoring device of the direct methanol fuel cell of the embodiment.

FIG. 5 illustrates an important part of the direct methanol fuel cell system of the embodiment.

FIG. 6 illustrates an important part of the direct methanol fuel cell system of another embodiment.

FIG. 7 illustrates an example of the operation monitoring device of the direct methanol fuel cell system of the embodiment.

FIG. 8 is a diagram comparing discharge characteristics of the direct methanol fuel cell system of the embodiment and those of a conventional direct methanol fuel cell system.

FIG. 9 is a diagram schematically illustrating the direct methanol fuel cell system of the embodiment.

FIG. 10 is a diagram schematically illustrating the direct methanol fuel cell system of another embodiment.

### EMBODIMENTS

In the following, a first embodiment will be described.

### Test 1

In the unit cell subjected to the test, Nafion (trademark) 117 being a polymer electrolyte membrane with proton conductivity was used as the electrolyte. The anode was a porous carbon paper coated with carbon powder supporting Pt—Ru catalyst (product of Tanaka Kikinzoku K.K.). The cathode was a carbon paper coated with carbon powder supporting Pt catalyst (product of Tanaka Kikinzoku K.K.). They were jointed by the hot pressing method to make a membrane-electrode-assembly (MEA), and this MEA was provided between graphite separators. The effective electrode surface area of this unit cell was 36 cm². This unit cell was heated up to 90° C., and a methanol aqueous solution of which concentration was 3 wt % as liquid fuel was fed at a rate of 10 milliliter/minute, and air as oxidant gas was fed at a rate of 2 liter/minute, and the output current was a constant current of 12 A. When the air flow rate was kept at 2. liter/minute, the flow rate of the methanol aqueous solution was reduced from 10 milliliter/minute, or when the flow rate of the methanol aqueous solution was set at 10 milliliter/minute, the air flow rate was reduced from 2 liter/minute. When the flow rate of the methanol aqueous solution was reduced to 2 milliliter/minute or under or the air flow rate was reduced to 0.6 liter/minute or under, potential reversal occurred and the reaction product at the anode blackened. Analysis of this reaction product revealed that a large amount of ruthenium that is hardly contained in the normal reaction product was contained in it. It was also found that this was the cause of the blackening of the reaction product. Hence it was found that such a phenomenon occurs when the supply of methanol aqueous solution or the supply of air is deficient.

### Test 2

A unit cell identical to that used in Test 1 was heated up to 90° C., and a methanol aqueous solution of 3 wt % concentration as liquid fuel was fed at a rate of 2 milliliter/minute, air as oxidant gas was fed at 0.6 liter/minute, and the output current was increased from 0 A in the form of constant current. When the output current was increased to 12 A or over, potential reversal occurred and the reaction product at the anode blackened. Analysis of this reaction product also revealed a large amount of ruthenium contained therein.

When the electric potential between the anode and the cathode of the unit cell at the time of blackening of the reaction product was examined in Test 1 and Test 2, respectively, it was found that potential reversal occurred in both cases, and a reverse potential of 0.5 to 0.6 V occurred. In succession to Test 1 and Test 2, the following Test 3 was conducted.

### Test 3

A unit cell identical to that used in Test 1 was heated up to 90° C., and a methanol aqueous solution of 3 wt % concentration as liquid fuel was fed at 2 milliliter/minute and air as oxidant gas was fed at 0.6 liter/minute. Under this condition, reverse voltages were applied continuously in such a way that the electric potential between the anode and the cathode becomes −200 mV, −400 mV, −600 mV, −800 mV, respectively, for 30 minutes each. Observation and analysis were made to check whether the reaction products on the anode side discolored and whether ruthenium was contained in the reaction products. The findings are shown in Table 1.

TABLE 1

| Electric potential | | |
|---|---|---|
| between anode and | Change in color | Ruthenium in reaction |
| cathode (mV) | of reaction product | product |
| −200 | No change. | Not detected. |
| −400 | No change. | Not detected. |
| −600 | Blackened. | Detected. |
| −800 | Blackened. | Detected. |

As shown in Table 1, when the reverse voltages were −200 mV and −400 mV, no change in color of the reaction products on the anode side was observed, and ruthenium was not present in the reaction products. In contrast to them, when the reverse voltages were −600 mV and −800 mV, both change in color of the reaction products on the anode side and presence of ruthenium in the reaction products were confirmed.

### Test 4

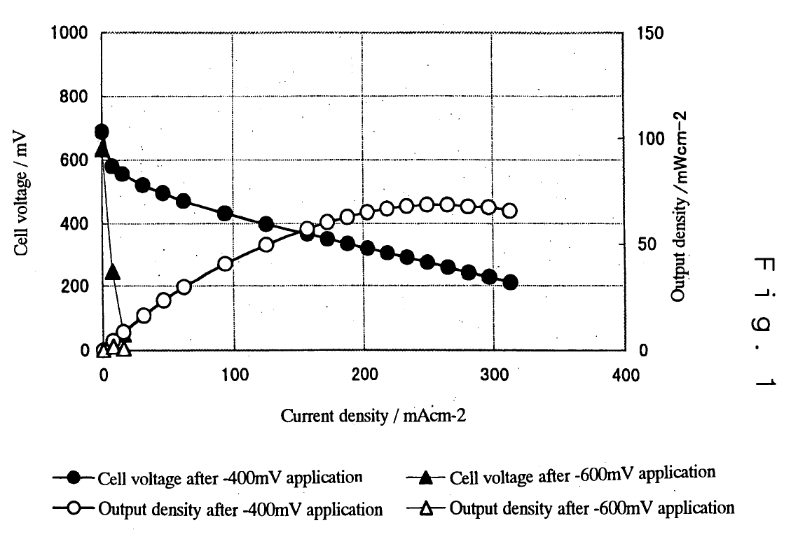

A unit cell identical to that used in Test 1 was heated up to 90° C., and a methanol aqueous solution of 3 wt % concentration as liquid fuel was fed at 8 milliliter/minute and air as oxidant gas was fed at 3 liter/minute. Under this condition, how the cell characteristics are changed after a reverse voltage wherein the, electric potential of the cathode is −400 mV in relation to the anode is applied and how the cell characteristics are changed after a reverse voltage of −600 mV is applied were analyzed by investigating the relationship between the output current and the output voltage. The findings are shown in FIG. 1.

After the application of the reverse voltage of −400 mV, neither any change in color of the reaction product on the anode side nor any presence of ruthenium in the reaction product were observed. Moreover, no changes in the cell characteristics were found. In contrast to it, after the application of the reverse voltage of −600 mV, both change in color of the reaction product on the anode side and presence of ruthenium in the reaction product were confirmed, and conspicuous deterioration in the cell characteristics was observed.

In the direct methanol fuel cell, when the supply of a methanol aqueous solution or the supply of air is deficient or when the output current is excessive in relation to the supply of the methanol aqueous solution or the supply of air, the electric potential of the cathode in relation to the anode will be reversed. When this electric potential drops to −600 mV, the methanol aqueous solution will function as an electrolytic solution because the methanol aqueous solution is kept in weak acidity by formic acid that is discharged from the anode side. As a result, Ruthenium being a component of the catalyst of the anode will dissolve electrochemically. Once ruthenium is eluted electrochemically, the catalytic function of the anode will deteriorate, and in turn the cell characteristics will deteriorate. In the case of a cell stack wherein a large number of unit cells are series-connected, if such a phenomenon occurs in a specific unit cell, it will cause deterioration of the characteristics of the entire cell stack. On the other hand, in the solid polymer fuel cell using hydrogen fuel, no reaction product is generated at the anode, and a small amount of water of high purity is dispersed from the cathode side. Hence, even if such a potential reversal takes place, ruthenium will not elute electrochemically. Thus the elution of ruthenium due to potential reversal is a problem unique to the liquid-fuel feed fuel cells.

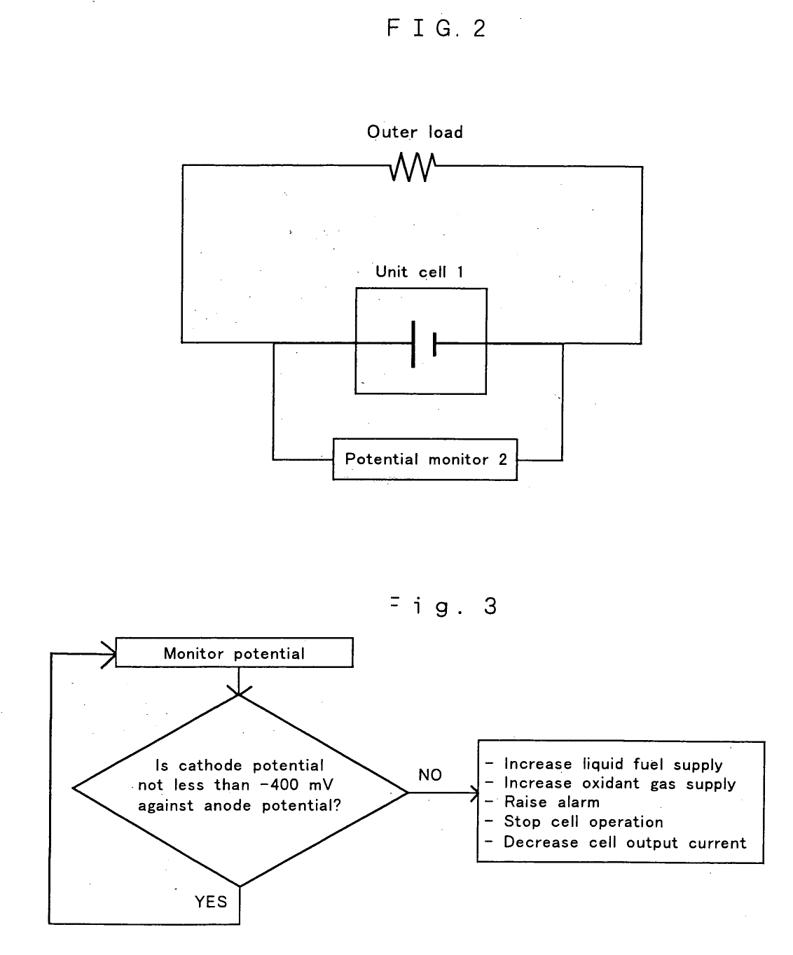

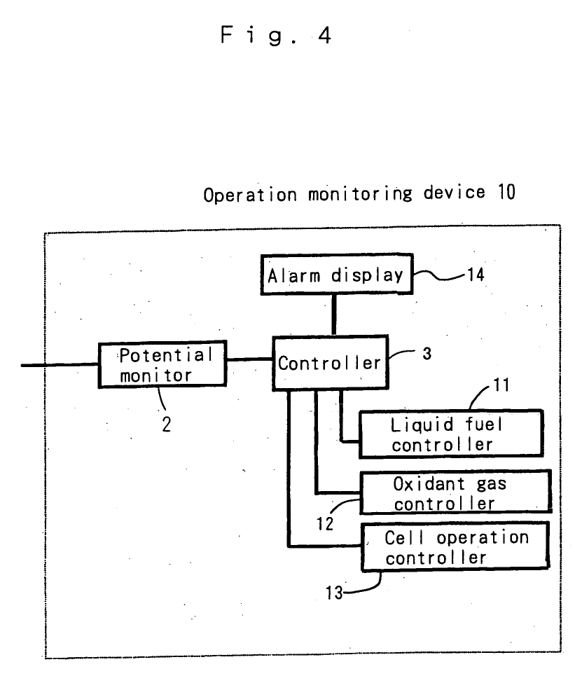

Now, on the basis of the results of Test 1 through Test 4, the liquid-fuel feed fuel cell of the present invention comprising one unit cell 1 as shown in FIG. 2 is provided with a potential monitor 2 for monitoring the electric potential between the anode and the cathode thereof. When this potential monitor 2 detects a predetermined negative potential, for example, −400 mV, at least one of increasing the supply of a liquid fuel or the supply of an oxidant gas, giving an alarm, reducing the output current of the cell and suspending the operation of the cell will be made. Additionally, in the operation monitoring method of the liquid-fuel feed fuel cell of the present invention, as shown in the flowchart of FIG. 3, the electric potential between the anode and the cathode thereof is monitored. When a predetermined negative potential, for example, −400 mV or under, is detected, at least one of increasing the supply of a liquid fuel or the supply of an oxidant gas, giving an alarm, reducing the output current of the cell and suspending the operation of the cell will be made. In an operation monitoring device 10 of the liquid-fuel feed fuel cell according to the present invention, as shown in FIG. 4, a potential monitor 2 for monitoring the electric potential between the anode and the cathode of a unit cell is provided. And a controller 3 is provided, which executes at least one of making a liquid fuel controller 11 increase the supply of the liquid fuel, making an oxidant gas controller 12 increase the supply of the oxidant gas, making an alarm display 14 give an alarm and making a cell operation controller 13 decrease the output current of the cell or suspend the operation of the cell when this potential monitor 2 detects a predetermined negative potential, for example, −400 mV. With this arrangement, the ruthenium in the catalyst of the anode can be prevented from electrochemical elution, and in turn the liquid-fuel feed fuel cell can be operated stably over a long period. In FIG. 2 through FIG. 4, the electric potential of a single unit cell is monitored. However, it is sufficient to monitor the electric potential of at least one unit cell in a cell stack comprising a plurality of unit cells.

In the embodiment, the electric potential between the anode and the cathode of a unit cell or at least one unit cell of a cell stack. However, a plurality of unit cells constituting a cell stack may be divided into a plurality of blocks comprising, for example, from two to six cells, and the electric potential between the anode and the cathode of each block may be monitored to detect occurrence of a reverse potential on a particular unit cell from the electric potential of the block. In this case, the smaller the number of unit cells in each block, the higher the precision of detection, but the number of the potential monitors will get larger. It, therefore, is desirable to form a plurality of blocks each comprising 2 to 6 cells, and more preferably, to form a plurality of blocks each comprising 3 to 5 cells.

In the liquid-fuel feed fuel cell according to the present invention, a unit cell, at least a unit cell or a block comprising a plurality of unit cells of a cell stack may be provided with, in place of a potential monitor, an electronic circuit such as a diode for preventing application of a reverse voltage due to potential reversal.

### Best Mode

In the cell and the cell of the cell stacks that constitute the direct methanol fuel cell system according to the present invention, Nafion 117 (trade name, “Nafion” is a registered trade mark of Dupont) being a polymer electrolyte membrane having proton conductivity was used as the electrolyte, a porous carbon paper coated with carbon powder supporting Pt—Ru catalyst was used as the anode, and carbon paper coated with carbon powder supporting Pt catalyst was used as the cathode. They were jointed by the hot pressing method at a temperature of 130° C. and a pressure of 980 N/cm² to form a membrane electrode assembly (MEA), and this membrane electrode assembly (MEA) was provided between graphite separators. The effective electrode area of this cell was 36 cm², and the cell stack comprises 10 cells series-connected.

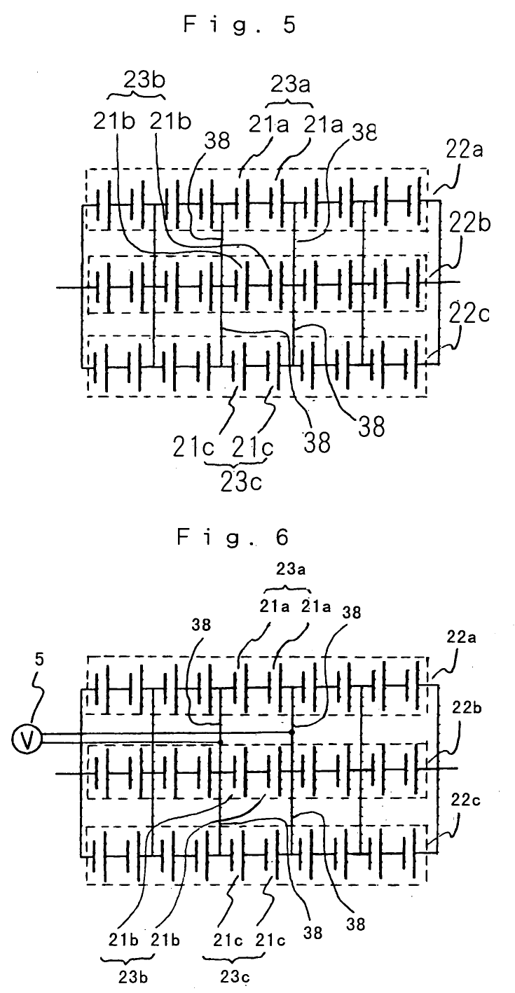

A total of six cell stacks were prepared, and three cell stacks were used to constitute the direct methanol fuel cell system according to the present invention, as shown in FIG. 5. In this system, each of the cell stacks 22a, 22b, 22c comprised five cell groups, each said cell group comprising two unit cells. The corresponding cell groups (cell groups taking the same positions) 23a, 23b, 23c of the respective cell stacks 22a, 22b, 23c were parallel-connected together with connecting wires 38.

In the system shown in FIG. 5, even if a specific unit cell deteriorates, or if the supply of methanol aqueous solution or the supply of air becomes uneven to the respective cells constituting the cell stack and the supply of methanol aqueous solution or the supply of air to a specific unit cell becomes deficient, the output current of the specific unit cell will drop extremely because the corresponding cell groups 23a, 23b, 23c of the respective cell stacks are connected together with the connecting wires 38.

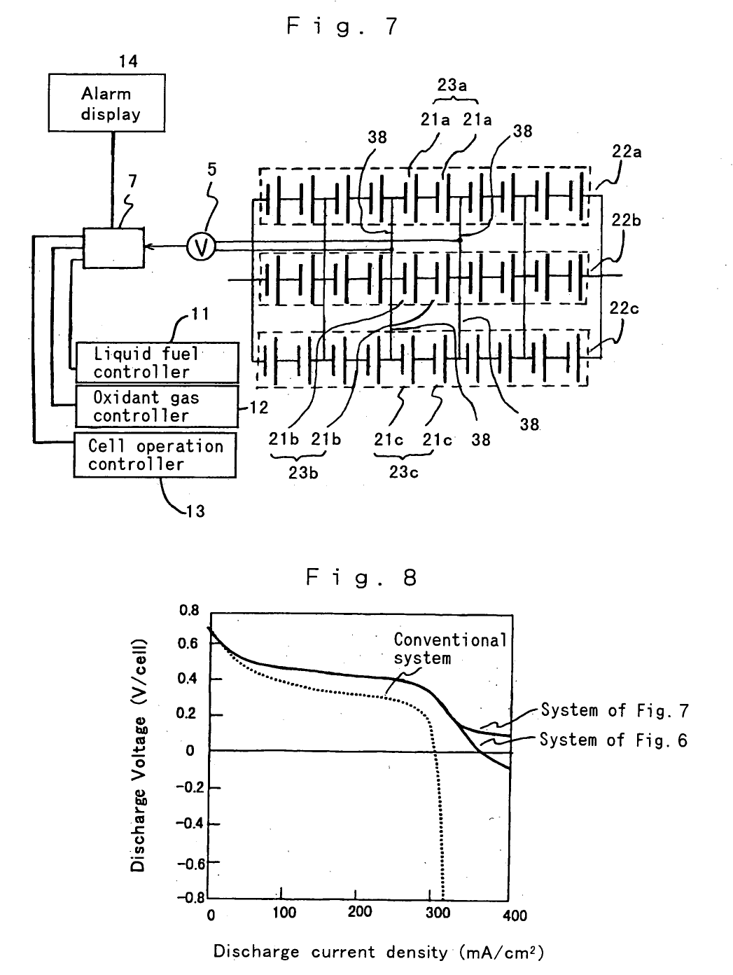

In contrast to it, in a system shown in FIG. 6, one cell group 23b (comprising two unit cells 21b series-connected) of one cell stack 22b is provided with a potential monitor 5, and the electric potential between the anode and the cathode of the cell group 23b is monitored by this potential monitor 5. When the electric potential is detected to be at a predetermined potential or under, at least one of increasing the supply of liquid fuel or the supply of oxidant gas to the cell stack 22b having the cell group 23b or the system, giving an alarm, decreasing the output current of the system and suspending the operation of the system will be done. The potential monitor 5 may be so arranged that it monitors the electric potential between the anode and the cathode of each unit cell 21b of the cell group 23b. The potential monitor 5 may be provided on at least one cell group other than the cell group 23b of the cell stack 22b. When the electric potential between the anode and the cathode of the unit cell 21b is monitored by the potential monitor 5, the preset voltage may be set at any value equal to −0.5 V or above. When the electric potential between the anode and the cathode of the cell group 23b is monitored, the preset voltage is set according to the number of cells in the cell group so that the voltage of any unit cell in the cell group is not −0.5 V or under. When the electric potential between the anode and the cathode of the cell group 23b is monitored, it is better to keep the number of cells in the cell group low. The reason is that if there is only one deteriorated cell among a plurality of sound cells, the change in the electric potential monitored will be small and it will be hard to detect the deteriorated cell.

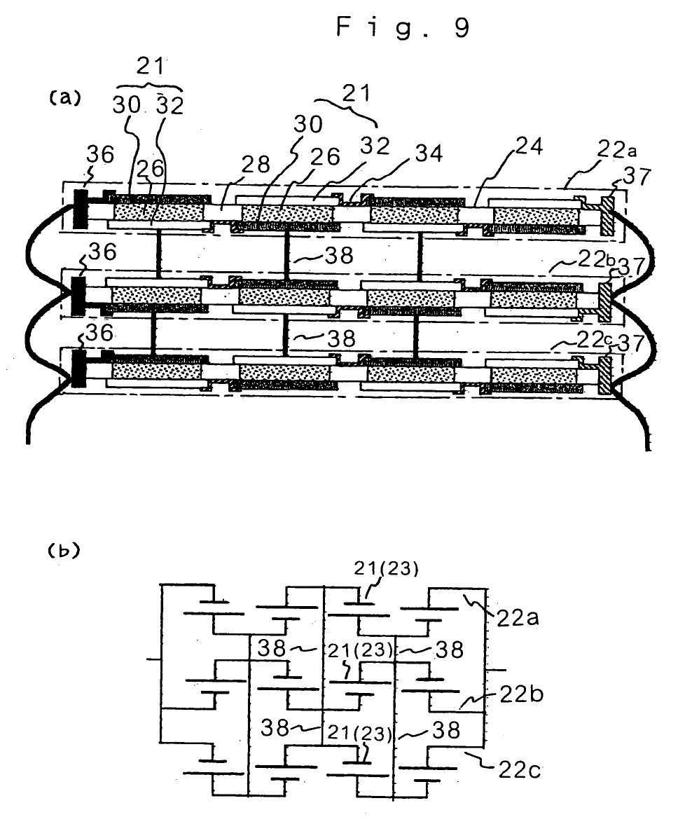

The system of FIG. 6 was heated up to 90° C., and a methanol aqueous solution of 3 wt % concentration as liquid fuel was fed per cell at a rate of 8 milliliter/minute, and air as oxidant gas was fed at a rate of 1 liter/minute and the system was operated. For the cell group 23b, the feed of methanol was reduced and the methanol aqueous solution was fed per cell at 1 milliliter/minute. As a conventional example for comparison, the methanol aqueous solution was fed to one unit cell of the cell stack at a rate of 1 milliliter/minute per cell, and the methanol aqueous solution was fed to other unit cells at a rate of 8 milliliter/minute. As for the air supply, the rate was 1 liter/minute for each unit cell. While the discharge voltage of the unit cell of which methanol supply was reduced was measured with the potential monitor 5, the current density was made to increase. The results are shown in FIG. 8.

As shown in FIG. 8, in the conventional system, which is the system of FIG. 5 from which the connecting wires 38 are removed, when the discharge current density approached 300 mA/cm², the discharge voltage began to drop, and when the discharge current density was 320 mA/cm², the discharge voltage read −0.6 V and occurrence of marked potential reversal was confirmed. In the system of FIG. 6 (of the present invention), when the discharge current density approached to about 300 mA/cm², the discharge voltage began to drop, however, occurrence of potential reversal was not confirmed until the discharge current density approached to about 360 mA/cm². In the conventional system, when the operation of the system with the discharge current density being at 320 mA/cm² was continued for about 30 minutes, the reaction product at the anode blackened and deterioration in the cell characteristics was found. In contrast to it, in the system of FIG. 6, when the discharge current density was 320 mA/cm², occurrence of potential reversal was not detected, and when the operation at that current density was continued for about 30 minutes, the reaction product at the anode did not change its color and no degradation of the cell stack characteristics was confirmed. In the system of FIG. 6 wherein the corresponding cell groups 23a, 23b, 23c of the cell stacks 22a, 22b, 22c are connected with connecting wires 38, the discharge current can be borne by the corresponding cell groups 23a, 23b, 23c through the connecting wires 38. In contrast to it, in the conventional system, the same current that flows through other unit cells flows through a cell 21b for which the flow rate of methanol aqueous solution feed is reduced, and the discharge voltage of that unit cell 21b will drop extremely. In the system of FIG. 7 wherein when the discharge voltage is detected to be equal to a predetermined value or under, the supply of methanol aqueous solution is increased to the cell stack or the system (which will be described later), when the discharge current density was raised to 400 mA/cm² (at that time the fuel supply was increased to 12 milliliter/minute), no potential reversal occurred. Here the discharge voltage per cell was set at 0.2 V so that occurrence of potential reversal in a single unit cell in the cell group 23b can be detected. Analysis of the blackened reaction product that was produced in the conventional case revealed a large amount of ruthenium that is hardly present in the normal reaction product.

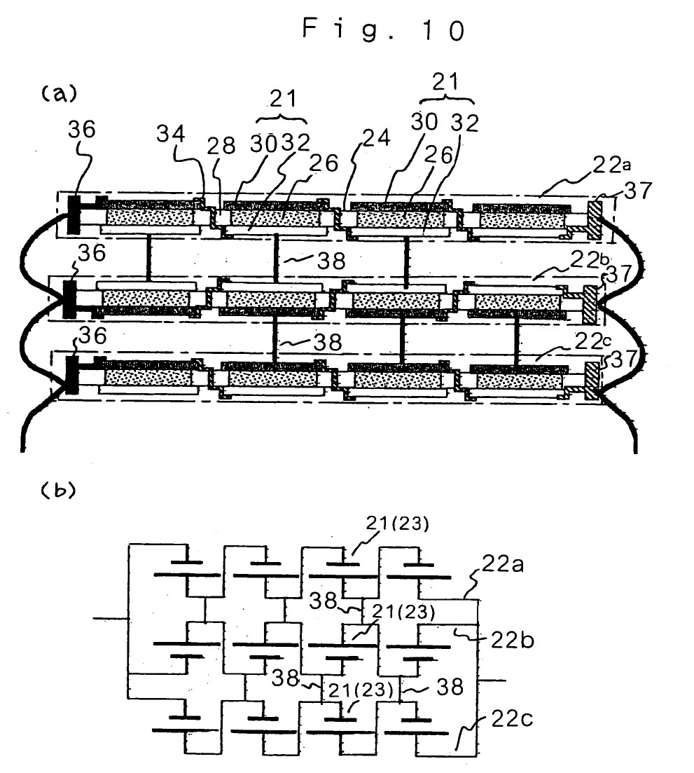

FIG. 9 and FIG. 10 schematically illustrate the direct methanol fuel cell system of the embodiment. In this system, as shown in FIG. 9(a) and FIG. 10(a), proton conductive parts 26 having proton conductivity are formed on parts of a single solid electrolyte membrane 24. Anodes 30 and cathodes 32 are formed on the front face and the back face of the proton conductive parts 26 to form a plurality of unit cells 21 side by side on the solid electrolyte membrane 24, and the spaces between respective cells 21 are impregnated with resin or the like to form insulating parts 28 having no proton conductivity. Connecting parts 34 are formed on the insulating parts 28 and the unit cells are electrically connected together by these connecting parts 34. With such a sheet type series connection, MEAs each comprising a plurality of cells are obtained, and these MEAs are made to be cell stacks 22a, 22b, 22c. The anode 30 is, for example, a mixture of conductive catalyst of C(carbon)-Pt—Ru and Nafion (registered trade mark) and PTFE (polytetrafluoroethylene). The ratio of Pt and Ru is 1:1.5 (mole ratio), the ratio of noble metals to (noble metals+carbon) is about 50 wt %, the weight ratio of catalyst:PTFE:Nafion is 55:17:28. The content of noble metals per unit electrode surface area is 1 mg/cm². Moreover, a backing layer such as carbon paper is provided on the liquid fuel channel side. As for the cathode 32, in place of the conductive catalyst of C (carbon)-Pt—Ru, preferably, a conductive catalyst of C (carbon)-Pt is used, and the noble metal is 100% of Pt, the ratio of the noble metal to (noble metal+carbon) is about 50 wt %, and the weight ratio of catalyst:PTFE:Nafion is 66:13:21. The content of noble metal per unit electrode surface area is 1 mg/cm². Other aspects are identical to those of the anode 30, and similarly, it is desirable to provide a backing layer such as carbon paper. For the systems shown in FIG. 9(a) and FIG. 10(a), the thickness of the proton conductive parts 26 is 180μm, and the thickness of the anode 30 and the cathode 32 is 200 μm. The anode 30 and the cathode 32 can be provided with a catalyst layer of from 100 to 500 μm, comprising conductive catalyst.

In the series-connection illustrated in FIG. 9(a), a connecting part 34 is provided between the anode 30 and the cathode 32 that is adjacent on the left side thereof, said connecting part 34 comprising an electron-conductive material such as metal plate, metal film, carbon paper or conductive polymer. And as to the layout direction of the anodes 30 and the cathodes 32, the anode 30 and the cathode 32 in predetermined directions are electronically connected. In the series-connection illustrated in FIG. 10(a), the anodes 30 are all formed on one surface of the solid electrolyte membrane 24, and the cathodes 32 are all formed on the other surface thereof, and the connecting parts 34 are formed to penetrate through the insulating parts 28. The anodes 30 and the cathodes 32, which are on the face and on the back of the solid electrolyte membrane 24 (proton conductive part 26), are electronically connected together with these connecting parts 34. 36 and 37 denote the output terminals of the cell stacks 22a-c. Terminals of the same polarity of the output terminals 36, 37 are connected together to parallel-connect the respective cell stacks 22a-c and construct the system. In the systems of the present invention, as shown in FIG. 9(a) and FIG. 10(a) and their connection diagrams, namely, FIG. 9(b) and FIG. 10(b), the cell groups 23 are formed by the individual unit cells 21 of the respective cell stacks 22a-c, and the corresponding cell groups 23 of the respective cell stacks 22a-c are parallel-connected by the connecting wires 38. The connecting wires 38 can be realized by providing conductive nets or carbon plates.

In the operation monitoring method and the operation monitoring device according to the present invention, as shown in FIG. 7, the electric potential between the anode and the cathode of a cell group 23b wherein two unit cells 21b are series-connected is monitored by a potential monitor 5. When the electric potential is detected to be equal to or under a predetermined electric potential, the controller 7 will increase, via the liquid fuel controller 11, the supply of liquid fuel to the cell stack 22b containing the cell group 23b or the system. Or the controller 7 increases, via the oxidant gas controller 12, the supply of oxidant gas to the cell stack 22b or the system, or gives an alarm with the alarm display 14, or reduce the output current of the system or suspend the operation of the system via the cell operation controller 13. The potential monitor 5 may monitor the electric potential between the anode and the cathode of on unit cell 21b or monitor the electric potential between the anode and the cathode of a plurality of cell groups 23b.

1-7. (canceled)

8. A liquid-fuel feed fuel cell, having at least a unit cell comprising: an anode having a Pt—Ru catalyst and a cathode having a Pt catalyst, opposed with each other; and a proton conductive polymer electrolyte interposed between said anode and said cathode, said anode being supplied a liquid-fuel of at least a member of a group consisting of methanol aqueous solution, isopropanol aqueous solution, and dimethylethel-water mixture, and the cathode being supplied an oxidant gas, said fuel cell further comprising:
detecting means for detecting a positive level of a potential of said anode in comparison with a potential of said cathode so as to detect a potential reversal between the anode potential and the cathode potential occurring; and
means for performing at least one of functions of increasing a supply of the liquid-fuel or the oxidant gas, raising an alarm, decreasing an output current of said fuel cell, and stopping an operation of said fuel cell, upon detecting said positive level, for preventing a Ru elution from said anode to said liquid-fuel.

9. The liquid-fuel feed fuel cell according to claim 8, said detecting means detecting said positive level being not less than 200 mV.

10. The liquid-fuel feed fuel cell according to claim 8, further comprising a cell stack having a plurality of said unit cells layered in series, and
said detecting means monitoring a potential difference between said anode and said cathode in at least one of said unit cells in said cell stack.

11. The liquid-fuel feed fuel cell according to claim 10, said detecting means monitoring said potential difference of each unit cell in said cell stack.

12. The liquid-fuel feed fuel cell according to claim 8, further comprising at least two cell stacks provided with a plurality of cell groups, each having at least one of said unit cell, and connected in series, said cell groups being connected in parallel with each other between the cell stacks,
said detecting means monitoring a potential difference between anodes and cathodes in the cell groups being connected in parallel to detect said positive level in any of said unit cell in the cell groups being connected in parallel.

13. The liquid-fuel feed fuel cell according to claim 12, said detecting means detecting said positive level being not less than 200 V.

14. An operation monitoring method for monitoring operation of liquid-fuel feed fuel cell having at least a unit cell comprising: an anode having a Pt—Ru catalyst and a cathode having a Pt catalyst, opposed with each other; and a proton conductive polymer electrolyte interposed between said anode and said cathode, said anode being supplied a liquid-fuel of at least a member of a group consisting of methanol aqueous solution, isopropanol aqueous solution, and dimethylethel-water mixture, and the cathode being supplied an oxidant gas,
said method performing at least one of functions of increasing a supply of the liquid-fuel or the oxidant gas, raising an alarm, decreasing an output current of said fuel cell, and stopping an operation of said fuel cell, upon detecting a positive level of a potential of said anode in comparison with a potential of said cathode so as to detect a potential reversal between the anode potential and the cathode potential occurring, for preventing a Ru elution from said anode to said liquid-fuel.

15. The operation monitoring method for monitoring operation of liquid-fuel feed fuel cell according to claim 14, detecting said positive level being not less than 200 mV.

16. An operation monitoring method for monitoring operation of liquid-fuel feed fuel cell according to claim 14, said fuel cell further comprising a cell stack having a plurality of unit cells layered in series, said method further comprising:
a step for monitoring a potential difference between the anode and the cathode in at least one unit cell in said cell stack to detect said positive level.

17. The operation monitoring method for monitoring operation of liquid-fuel feed fuel cell according to claim 16, monitoring each of potential differences in the unit cells in the cell stack.

18. An operation monitoring device of a liquid-fuel feed fuel cell having at least a unit cell comprising: an anode having a Pt—Ru catalyst and a cathode having a Pt catalyst, opposed with each other; and a proton conductive polymer electrolyte interposed between said anode and said cathode, said anode being supplied a liquid-fuel of at least a member of a group consisting of methanol aqueous solution, isopropanol aqueous solution, and dimethylethel-water mixture, and the cathode being supplied an oxidant gas, said device comprising:
detecting means for detecting a positive level of a potential of said anode in comparison with a potential of said cathode so as to detect a potential reversal between the anode potential and the cathode potential occurring; and
means for performing at least one of functions of increasing a supply of the liquid-fuel or the oxidant gas, raising an alarm, decreasing an output current of said fuel cell, and stopping an operation of said fuel cell, upon detecting said positive level, for preventing a Ru elution from said anode to said liquid-fuel.

19. An operation monitoring device of a liquid-fuel feed fuel cell according to claim 18, said detecting means detecting said positive level being not less than 200 mV.

20. The operation monitoring device of a liquid-fuel feed fuel cell according to claim 11, the fuel cell further comprising a cell stack having a plurality of the unit cells layered in series,
said detecting means monitoring a potential difference between the anode and the cathode in at least one unit cell in said cell stack.

21. The operation monitoring device of liquid-fuel feed fuel cell according to claim 18, said detecting means monitoring each of potential differences in the unit cells in said cell stack.
